(19) United States
(12) Patent Application Publication
(10) Pub. No.: US 2025/0349053 A1
(43) Pub. Date: Nov. 13, 2025

(54) Geological Mapping

(71) Applicant: PlotLogic Pty Ltd, Queensland (AU)

(72) Inventor: Andrew Job, Queensland (AU)

(73) Assignee: PlotLogic Pty Ltd, Queensland (AU)

(21) Appl. No.: 19/103,726

(22) PCT Filed: Jul. 13, 2023
(86) PCT No.: PCT/AU2023/050646

§ 371 Date: Feb. 13, 2025

(30) Foreign Application Priority Data
Aug. 15, 2022 (AU) 2022902312

(51) Int. Cl. G06T 11/60; G01V 8/02; G01V 20/00; G06T 7/11; G06T 7/12; G06V 10/764; G06V 20/10

(52) U.S. Cl. CPC G06T 11/60; G01V 8/02; G01V 20/00; G06T 7/11; G06T 7/12; G06V 10/765; G06V 20/194; G06T 2207/10036

(57) ABSTRACT

The present invention relates to a geological mapping method. The method includes receiving scan data relating to a geological structure. The data is processed to determine one or more regions of interest. The method further includes displaying a geo-spatially accurate map of the geological structure showing the regions of interest. Advantageously, the map showing the regions of interest may be rapidly generated, without the need for manual review and adjustment by a geologist. The mapping method may be accurate, consistent and repeatable without the need for manual review and adjustment by a geologist.

### TECHNICAL FIELD

The present invention relates to geological mapping.

### BACKGROUND

The reference to any prior art in this specification is not, and should not be taken as an acknowledgement or any form of suggestion that the prior art forms part of the common general knowledge.

A mobile mining spectral scanner can be used to perform hyperspectral scanning of a mine, including scanning of mine faces, muck piles, core and stockpiles. Geologists or other subject matter experts can then generate maps for use in geological modelling, mine planning, scheduling, or to guide manual or autonomous machinery.

The maps are manually generated through review and adjustment of the hyperspectral data which is a laborious process. The maps are undesirably prone to variation depending upon the particular geologist, if indeed a geologist is present at all.

The present invention provides for an improved mapping method.

### SUMMARY OF THE INVENTION

According to one aspect of the present invention, there is provided a geological mapping method including:
receiving scan data relating to a geological structure;
processing the data to determine one or more regions of interest; and
displaying a geo-spatially accurate map of the geological structure showing the regions of interest.

Advantageously, the map showing the regions of interest may be rapidly generated, without the need for manual review and adjustment by a geologist. The mapping method may be accurate, consistent and repeatable without the need for manual review and adjustment by a geologist. Preferably, the method is automated.

The method may involve capturing the scan data using a hyperspectral imaging device. The method may involve forming a hyperspectral data cube. The hyperspectral data cube may include two or more spatial dimensions (representing location in 2D or 3D space) and one spectral dimension.

The step of processing may involve estimating the presence and/or quantitative abundance of one or more minerals for each spatial pixel of the map using the data. The step of estimating may utilise analytical techniques for hyperspectral classification (e.g. spectral angle mapping) or a machine learning approach. The step of estimating may involve producing a 2-dimensional image for each mineral representing the mineral presence and/or abundance.

The step of estimating may involve specifying rules or parameters relating to the minerals. The rules or parameters may include a range for a mineral or a classified result (e.g. cut-off grades, presence of deleterious material, etc). The rules or parameters may be automatically specified through machine learning. The rules or parameters may be specified based upon a given mine or from subject matter expert guidance.

Optionally, the step of processing may involve aggregating the estimated presence and/or abundance for more than one of the minerals.

The step of processing may involve thresholding the estimated presence and/or abundance of one or more minerals so that levels above a threshold form part of the regions of interest.

The method may involve contouring to form contours denoting the regions of interest. The step of contouring may involve using a computer vision edge detection to locate edges defined by pixels of the map. The edge detection may involve using a canny filter.

The method may involve filtering regions of interest displayed on the map based upon one or more parameters. The parameters may include size and/or shape.

The method may involve mapping the regions of interest from two-dimensions (2D) to three-dimension (3D).

The geological structure may include one or more of a mine, mine faces, muck piles, core and stockpiles.

According to another aspect of the present invention, there is provided a geological mapping system including: a scanner for capturing scan data relating to a geological structure; a processor for processing the data to determine one or more regions of interest; and a display for displaying a geo-spatially accurate map of the geological structure showing the regions of interest.

The system may include an adjustment tool for adjusting parameters affecting the displayed map including minerals in the regions of interest, sizes of regions of interest, noise reduction, sharpness or blurring, or characteristics of the scan data.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic drawing of an automated geological mapping system in accordance with an embodiment of the present invention;

FIG. 2A shows a raw hyperspectral scan captured using the system of FIG. 1;

FIG. 2B shows a displayed map showing geological regions of interest identified using the hyperspectral scan of FIG. 2A;

FIG. 2C shows the filtered map of FIG. 2B; and

FIG. 3 is a flowchart of an automated geological mapping method performed using the system of FIG. 1.

### DETAILED DESCRIPTION OF PREFERRED EMBODIMENTS

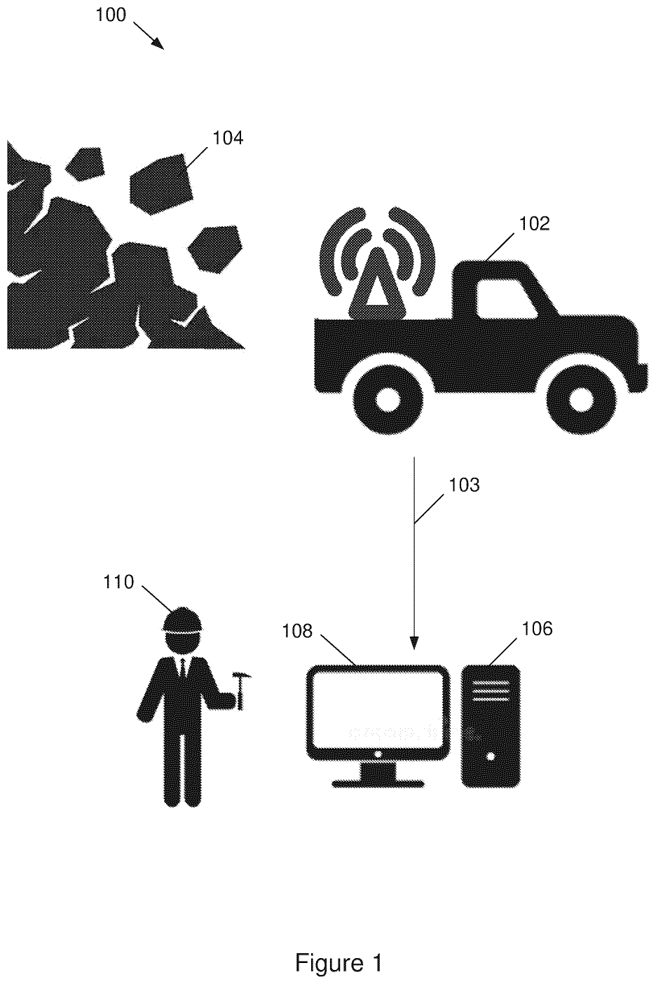

According to an embodiment of the present invention, there is provided an automated geological mapping system 100 as shown in FIG. 1. The mapping system 100 includes a mobile hyperspectral scanner 102, which is an imaging device for capturing scan data 103 relating to a mine 104. The mine 104 may include mine faces, muck piles, core, stockpiles and other like geological structures.

The mapping system 100 also includes a base processor 106 for processing of the hyperspectral scan data 103 to determine one or more geological regions of interest. An electronic display 108 is provided for displaying a geo-spatially accurate map of the mine 104 showing the geological regions of interest to a geologist 110.

The base processor 106 is typically in wireless communication with the remote scanner 102, and is also networked to the cloud for enabling the geologist 110 to utilise stored scan data 103 and software via a web-based portal.

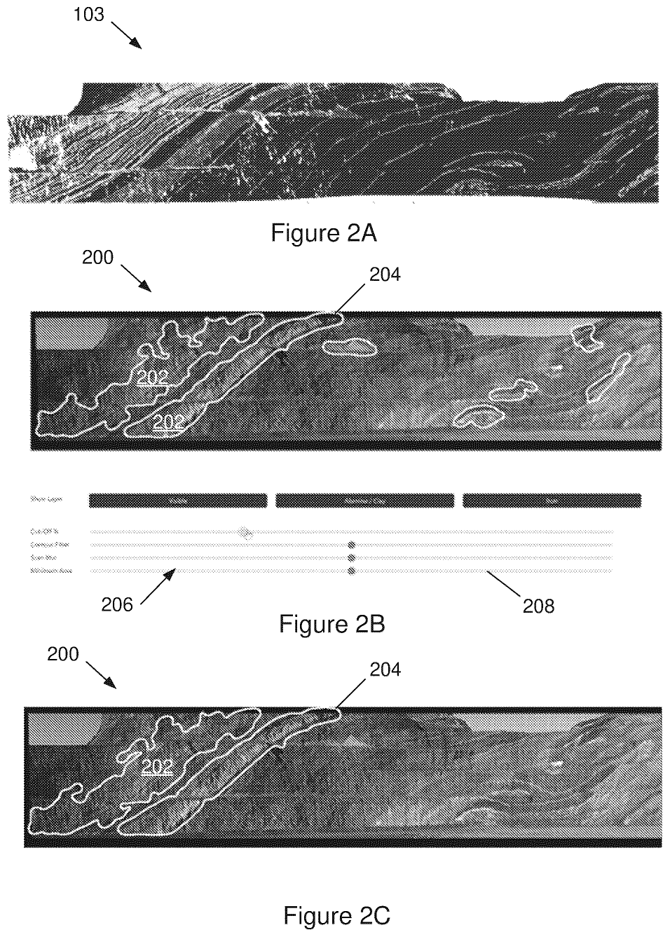

FIG. 2A shows a displayed raw hyperspectral scan 103 captured using the system 100.

FIG. 2B shows the displayed map 200 showing determined geological regions of interest 202, bounded by contours 204, identified using the hyperspectral scan 103.

The system 100 also includes an electronic adjustment tool 206 for adjusting parameters affecting the displayed map 200 including minerals in the regions of interest 202, sizes of regions of interest 202, noise reduction, sharpness or blurring, or characteristics of the scan data 103. For example, a slider 208 of the adjustment tool 206 can be adjusted to filter out and remove smaller regions of interest 202 as shown in FIG. 2C.

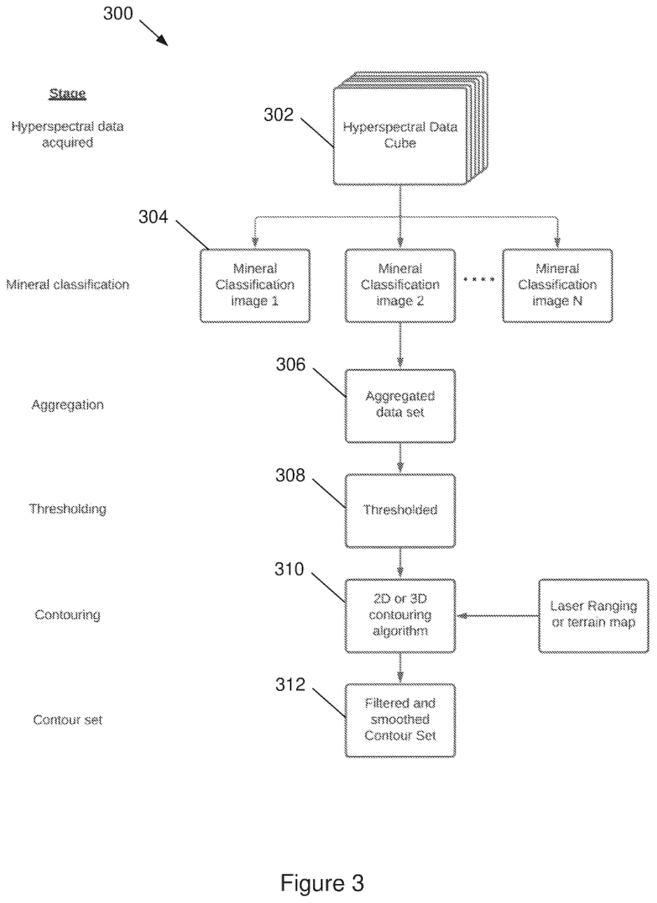

An automated geological mapping method 300 using the system 100 is now described with reference to FIG. 3.

Initially, the mobile hyperspectral imaging scanner 102 drives around the mine 104 capturing the hyperspectral scan data 103. In turn, the processor 106 receives the hyperspectral scan data 103 relating to the mine 102. The processor 106 then processes the data 103 to determine the one or more regions of interest 202, as explained in detail below.

At step 302, the processing involves forming a hyperspectral data cube using the acquired hyperspectral scan data 103. The hyperspectral data cube includes two or more spatial dimensions (representing location in 2D or 3D space) and one spectral dimension.

At step 304, the processing involves estimating the presence and/or quantitative abundance of one or more minerals for each spatial pixel of the digital map 200 using the data 103. This step of estimating utilises analytical techniques for hyperspectral classification (e.g. spectral angle mapping) or a machine learning approach. The estimating involves producing a 2-dimensional image for each mineral representing the mineral presence and/or abundance.

The estimating also involves specifying rules or parameters relating to the minerals. The rules or parameters can include a range for a mineral or a classified result (e.g. cut-off grades, presence of deleterious material, etc). The rules or parameters can be automatically specified through machine learning. The rules or parameters can be specified based upon a given mine or from subject matter expert guidance.

At optional step 306, the processing involves aggregating the estimated presence and/or abundance for multiple minerals. As an example, the user 110 may wish to combine classifications for multiple clay based minerals together to derive a single measure of clay abundance. Alternatively, a user may chose to combine a map 200 of copper and iron classifications to derive a proxy representation for mineral recovery potential. Otherwise, an estimate for a single mineral can be used for further processing.

At step 308, the processing involves thresholding the estimated presence and/or abundance of one or more minerals so that levels above a threshold form part of the regions of interest 202. A user defined threshold is applied (e.g. at a cut-off percentage of iron) to the mineral classification or aggregated output such that the output is a binary image set to 1 where there is a region of interest 202.

At step 310, the processing involves contouring to form the visible contours 204 surrounding the regions of interest 202, adjoining regions of disinterest. The contouring involves using a computer vision edge detection (e.g. a canny filter) to locate edges defined by pixels of the map 200. One or more contours 204 are formed around regions of interest 202 by linking together neighbouring edge pixels of interest. The contouring process results in either no contours, or a set of contours 204 that delineate the edges of a region of interest 202. Laser ranging or terrain mapping techniques can be optionally used to enhance the contouring process.

At step 312, processing can involve filtering regions of interest 202 to be displayed on the map 200 based upon one or more parameters using the adjustment tool 206 (See FIGS. 2B and 2C). The parameters can include size and/or shape of the regions of interest 202 denoted by contours 204.

The processing can involve mapping the regions of interest 202 from two-dimensions (2D) to three-dimensions (3D) by using terrain data, or the received scan data 103 from the hyperspectral imaging device 102.

As shown in FIG. 2C, the method then involves displaying, on display 108, the resultant filtered map 200 of the mine 104 showing the regions of interest 202.

Advantageously, the map 200 showing the regions of interest 202 can be rapidly generated, without the need for manual review and adjustment by a geologist 110. The mapping method 300 is accurate, consistent and repeatable without the need for manual review and adjustment by the geologist 110, which is useful for auditing purposes. Having a geologist 110 in the loop assists in improvement of accuracy, however the automated method 300 is conducted without manual intervention once sufficient information is learned.

The map 200 outputs can be used directly in a number of workflows including:
Applying constraints or quantitative measurements to a geological model;
Delineation in ore grades & waste boundaries can be used by dig operators, or automation, to drive dig strategy (and hence make significant improvements to recovery and dilution); and
Design of slope stability by identification and measurement of geotechnical risk.

A person skilled in the art will appreciate that many embodiments and variations can be made without departing from the ambit of the present invention.

In one embodiment, scan data other than hyperspectral imaging scan data 103 is used.

In one embodiment, shading instead of contours 204 is used to denote the regions of interest 202.

At estimating step 304, rules can be developed through machine learning based on inputs and adjustments made by subject matter experts 110. Subject matter experts 110 are provided an opportunity to adjust automatically generated outputs to suit their requirements. This provides a chance for the automated method 300 to learn improvements for future use. Adjustments can be made via numerical, text or user interface elements such as sliders or switches, for example using the adjustment tool 206, and may allow the ability specify parameters such as:
specifications for abundance or properties of one or multiple minerals of interest
size of regions of interest (e.g. maximum or minimum areas/volumes)
noise reduction, sharpness or blurring or input data

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1: A geological mapping method including:
receiving scan data relating to a geological structure;
processing the data to determine one or more regions of interest; and
displaying a geo-spatially accurate map of the geological structure showing the regions of interest.

2: A geological mapping method as claimed in claim 1, wherein the map showing the regions of interest are rapidly generated, without the need for manual review and adjustment by a geologist.

3: A geological mapping method as claimed in claim 1, which is accurate, consistent and repeatable without the need for manual review and adjustment by a geologist.

4: A geological mapping method as claimed in claim 1, involving capturing the scan data using a hyperspectral imaging device.

5: A geological mapping method as claimed in claim 4, involving forming a hyperspectral data cube.

6: A geological mapping method as claimed in claim 5, wherein the hyperspectral data cube includes two or more spatial dimensions, representing location in 2D or 3D space, and one spectral dimension.

7: A geological mapping method as claimed in claim 1, wherein the step of processing involves estimating the presence and/or quantitative abundance of one or more minerals for each spatial pixel of the map using the data.

8: A geological mapping method as claimed in claim 7, wherein the step of estimating utilises analytical techniques for hyperspectral classification, spectral angle mapping or a machine learning approach.

9: A geological mapping method as claimed in claim 7, wherein the step of estimating involves producing a 2-dimensional image for each mineral representing the mineral presence and/or abundance.

10: A geological mapping method as claimed in claim 7, wherein the step of estimating involves specifying rules or parameters relating to the minerals.

11: A geological mapping method as claimed in claim 10, wherein the rules or parameters include a range for a mineral or a classified result.

12: A geological mapping method as claimed in claim 10, wherein the rules or parameters are automatically specified through machine learning.

13: A geological mapping method as claimed in claim 10, wherein the rules or parameters are specified based upon a given mine or from subject matter expert guidance.

14: A geological mapping method as claimed in claim 7, wherein the step of processing involves aggregating the estimated presence and/or abundance for more than one of the minerals.

15: A geological mapping method as claimed in claim 14, wherein the step of processing involves thresholding the estimated presence and/or abundance of one or more minerals so that levels above a threshold form part of the regions of interest.

16: A geological mapping method as claimed in claim 1, further involving contouring to form contours denoting the regions of interest.

17: A geological mapping method as claimed in claim 16, wherein the step of contouring involves using a computer vision edge detection to locate edges defined by pixels of the map, preferably using a canny filter.

18: A geological mapping method as claimed in claim 1, involving filtering regions of interest displayed on the map based upon one or more parameters, the parameters preferably including size and/or shape.

19: A geological mapping method as claimed in claim 1, further involving mapping the regions of interest from two-dimensions (2D) to three-dimensions (3D).

20. (canceled)

21: A geological mapping system including:
a scanner for capturing scan data relating to a geological structure;
a processor for processing the data to determine one or more regions of interest; and
a display for displaying a geo-spatially accurate map of the geological structure showing the regions of interest.

22. (canceled)
